(19) United States
(12) Patent Application Publication
(10) Pub. No.: US 2013/0112628 A1
(43) Pub. Date: May 9, 2013

(54) TREATMENT SOLUTION SUPPLY METHOD, NON-TRANSITORY COMPUTER STORAGE MEDIUM AND TREATMENT SOLUTION SUPPLY APPARATUS

(71) Applicant: Tokyo Electron Limited, Tokyo (JP)

(72) Inventors: Kousuke Yoshihara, Koshi City (JP); Toshinobu Furusho, Koshi City (JP)

(73) Assignee: TOKYO ELECTRON LIMITED, Tokyo (JP)

(21) Appl. No.: 13/662,998

(22) Filed: Oct. 29, 2012

(30) Foreign Application Priority Data
Nov. 4, 2011 (JP) 2011-242338

(51) Int. Cl. E03B 7/07; B01D 37/00

(52) U.S. Cl. 210/767; 137/544

(57) ABSTRACT

A treatment solution supply method of the present invention is for supplying a treatment solution from a treatment solution supply source to a treatment solution supply unit supplying the treatment solution to a substrate, wherein a supply pipe connected to the treatment solution supply unit is provided with a filter collecting foreign matter in the treatment solution and not allowing the foreign matter to be released therefrom, and the treatment solution flowing in the supply pipe is caused to pass through the filter in a reciprocation manner at least one time and then supplied to the treatment solution supply unit, so that the foreign matter in the treatment solution can be sufficiently removed and the collected foreign matter never mixes again into the treatment solution.

### BACKGROUND OF THE INVENTION

1. Field of the Invention

The present invention relates to a treatment solution supply method for supplying a treatment solution to a treatment solution supply unit supplying the treatment solution to a substrate, a non-transitory computer storage medium, and a treatment solution supply apparatus for performing the treatment solution supply method.

2. Description of the Related Art

For example, in a photolithography process in manufacturing processes of a semiconductor device, resist coating treatment of applying a resist solution onto, for example, a semiconductor wafer (hereinafter, referred to as a “wafer”) to form a resist film, exposure processing of exposing the resist film to a predetermined pattern, developing treatment of developing the exposed resist film and so on are sequentially performed, whereby a predetermined resist pattern is formed on the wafer.

In the above-described resist coating treatment, a so-called spin coating method of discharging the resist solution, for example, from a coating nozzle onto the wafer, and rotating the wafer to diffuse the resist solution over the front surface of the wafer is widely used. Further, to the coating nozzle, the resist solution is supplied from a resist solution supply source storing the resist solution therein via a supply pipe.

Incidentally, the resist solution stored in the aforementioned resist solution supply source sometimes has foreign matter mixed therein. Further, during the time when the resist solution is stored in the resist solution supply source, a polymer-based compound of the resist solution sometimes aggregates with time to generate gel insoluble matter. If such foreign matter is supplied together with the resist solution onto the wafer, the foreign matter remains in the resist film which will be formed afterward, so that the resist pattern cannot be appropriately formed, resulting in defects of the wafer. Therefore, a filter has been conventionally provided in the supply pipe connecting the resist solution supply source and the coating nozzle to cause the resist solution to pass through the filter to thereby remove the foreign matter in the resist solution.

However, since the resist solution is supplied to the coating nozzle after passing through the filter only one time in the above-described method, the foreign matter in the resist solution cannot be sufficiently removed in some cases. In particular, miniaturization of the resist pattern is required as semiconductor devices becomes more highly integrated in recent years, exposing a problem of defects due to the foreign matter.

Hence, it is suggested to circulate the resist solution in a circulation path before supplying the resist solution to the coating nozzle and cause the resist solution to pass through the filter provided in the circulation path a plurality of times to thereby remove the foreign matter in the resist solution (Japanese Laid-open Patent Publication No. 2008-305980).

### SUMMARY OF THE INVENTION

However, in the case of removing the foreign matter in the resist solution using the method described in the aforementioned prior document, the circulation path for circulating the resist solution therein needs to be provided, leading to an increase in size of the apparatus supplying the resist solution.

Further, for example, when a new resist solution is supplied during the circulation of the resist solution in the circulation path, the circulating resist solution and the newly supplied resist solution mix together, failing to control the number of times of passage of the resist solutions through the filter. As a result, the foreign matter in the resist solutions cannot be sufficiently removed in some cases to generate defects due to the foreign matter.

The present invention has been made in consideration of the points, and its object is to reduce foreign matter in a treatment solution to reduce defects of a substrate.

To achieve the above object, the present invention is a treatment solution supply method for supplying a treatment solution to a treatment solution supply unit supplying the treatment solution to a substrate, wherein a supply pipe connected to the treatment solution supply unit is provided with a filter collecting foreign matter in the treatment solution and not allowing the foreign matter to be released therefrom, and wherein the treatment solution flowing in the supply pipe is caused to pass through the filter in a reciprocation manner at least one time and then supplied to the treatment solution supply unit.

According to the present invention, the treatment solution flowing in the supply pipe is caused to pass through the filter in a reciprocation manner at least one time, namely, the treatment solution can be caused to pass through the filter a plurality of times, so that the foreign matter in the treatment solution can be sufficiently removed. In this event, the filter does not allow the collected foreign matter to be released therefrom, so that even if the treatment solution is caused to reciprocate, the foreign matter never mixes again into the treatment solution. Further, by controlling drive of the pump for moving the treatment solution in a reciprocation manner in the supply pipe, the number of times of passage of the treatment solution through the filter can be easily controlled. Consequently, the foreign matter in the treatment solution can be more surely removed. Then, the treatment solution from which the foreign matter has been removed is supplied to the substrate via the treatment solution supply unit as described above, thereby making it possible to reduce defects of the substrate. In addition, the treatment solution is caused to pass through the filter in a reciprocation manner, thus eliminating the necessity of separately providing the circulation path as in the prior art. Therefore, the foreign matter in the treatment solution can be removed using the resist solution supply apparatus in a simple configuration. Consequently, the manufacturing cost of the apparatus can be reduced and the occupied area of the apparatus can also be reduced.

Each of a flow path for the treatment solution on an upstream side of the filter and a flow path for the treatment solution on a downstream side of the filter may be configured to be capable of temporarily storing a predetermined supply amount of the treatment solution to be supplied from the treatment solution supply unit to the substrate. Note that the upstream side and the downstream side of the filter respectively refer to the upstream side and the downstream side with respect to a direction in which the treatment solution flows to the treatment solution supply unit. Further, the flow path for the treatment solution includes a supply pipe for the treatment solution, and a trap, a tank, a pump and so on provided in the supply pipe. Accordingly, to enable storage of a predetermined amount of the treatment solution in the flow path for the treatment solution, the supply pipe may have a length capable of storing the predetermined supply amount of the treatment solution or the trap, the tank, or the pump provided in the supply pipe may be capable of storing the predetermined supply amount of the treatment solution. Furthermore, the predetermined supply amount refers to a supply amount of the treatment solution for one dose to be supplied from the treatment solution supply unit to the substrate.

The present invention according to another aspect is a non-transitory computer-readable storage medium storing a program operating on a computer of a control unit controlling a treatment solution supply apparatus to cause the treatment solution supply apparatus to perform the treatment solution supply method.

The present invention according to still another aspect is a treatment solution supply apparatus for supplying a treatment solution to a treatment solution supply unit supplying the treatment solution to a substrate, including: a treatment solution supply source storing the treatment solution therein; a supply pipe for supplying the treatment solution from the treatment solution supply source to the treatment solution supply unit; a filter provided in the supply pipe for collecting foreign matter in the treatment solution and not allowing the foreign matter to be released therefrom; a pump provided in the supply pipe for causing the treatment solution to flow; and a control unit controlling the pump to cause the treatment solution flowing in the supply pipe to pass through the filter in a reciprocation manner at least one time and then supply the treatment solution to the treatment solution supply unit.

### BRIEF DESCRIPTION OF THE DRAWINGS

FIG. 1 is a longitudinal sectional view illustrating the outline of a configuration of a resist coating apparatus to which a resist solution is supplied from a resist solution supply apparatus according to an embodiment;

FIG. 2 is a transverse sectional view illustrating the outline of the configuration of the resist coating apparatus to which the resist solution is supplied from the resist solution supply apparatus according to this embodiment;

FIG. 3 is an explanatory view illustrating the outline of the configuration of the resist solution supply apparatus according to this embodiment;

FIG. 4 is an explanatory view illustrating the outline of a configuration of a resist solution supply apparatus according to another embodiment; and

FIG. 5 is an explanatory view illustrating the outline of a configuration of a resist solution supply apparatus according to another embodiment.

### DETAILED DESCRIPTION OF THE INVENTION

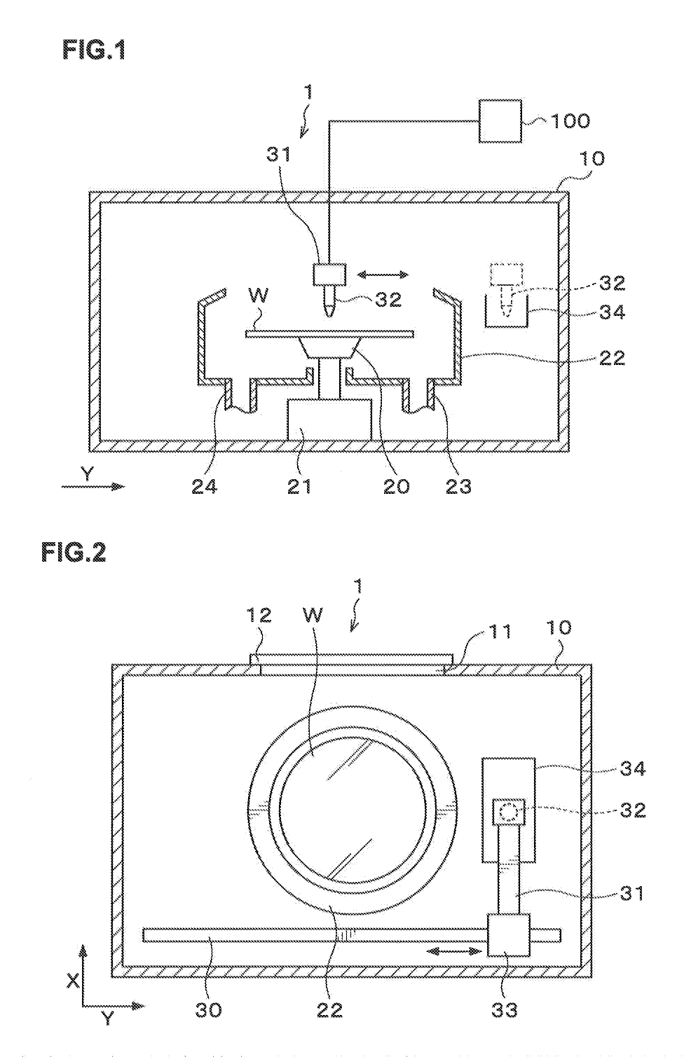

Hereinafter, an embodiment of the present invention will be described. In this embodiment, a form of supplying a resist solution as a treatment solution to a wafer as a substrate will be described. FIG. 1 is a longitudinal sectional view illustrating the outline of a configuration of a resist coating apparatus to which the resist solution is supplied from a resist solution supply apparatus as a treatment solution supply apparatus according to this embodiment. FIG. 2 is a transverse sectional view illustrating the outline of the configuration of the resist coating apparatus.

The resist coating apparatus 1 has a treatment container 10 capable of closing its inside as illustrated in FIG. 1. In a side surface of the treatment container 10 facing a transfer-in region for a transfer arm (not illustrated) of a wafer W, a transfer-in/out port 11 for the wafer W is formed as illustrated in FIG. 2, and an opening/closing shutter 12 is provided at the transfer-in/out port 11.

At a central part in the treatment container 10, a spin chuck 20 for holding and rotating the wafer W is provided as illustrated in FIG. 1. The spin chuck 20 has a horizontal upper surface, and a suction port (not illustrated) for sucking, for example, the wafer W is provided in the upper surface. By suction through the suction port, the wafer W can be suction-held on the spin chuck 20.

The spin chuck 20 has a chuck drive mechanism 21 including, for example, a motor and the like and can rotate at a predetermined speed by means of the chuck drive mechanism 21. The chuck drive mechanism 21 is further provided with a lifting drive source such as a cylinder so that the spin chuck 20 is movable up and down.

Around the spin chuck 20, a cup 22 is provided which receives and collects liquid scattering or dropping from the wafer W. A drain pipe 23 for draining the collected liquid and an exhaust pipe 24 for exhausting the atmosphere in the cup 22 are connected to a lower surface of the cup 22.

As illustrated in FIG. 2, on an X-direction negative direction (bottom direction in FIG. 2) side of the cup 22, a rail 30 extending in a Y-direction (right-left direction in FIG. 2) is formed. The rail 30 extends, for example, from a Y-direction negative direction (left direction in FIG. 2) side outer position of the cup 22 to a Y-direction positive direction (right direction in FIG. 2) side outer position of the cup 22. An arm 31 is attached to the rail 30.

On the arm 31, a coating nozzle 32 as a treatment solution unit supplying the resist solution is supported as illustrated in FIG. 1 and FIG. 2. The arm 31 is movable on the rail 30 by means of a nozzle drive unit 33 illustrated in FIG. 2. Therefore, the coating nozzle 32 can move from a waiting section 34 provided at the Y-direction positive direction side outer position of the cup 22 to a position above the center portion of the wafer W in the cup 22, and can further move above the front surface of the wafer W in a diameter direction of the wafer W. Further, the arm 31 is movable up and down by means of the nozzle drive unit 33 to be able to adjust the height of the coating nozzle 32. The coating nozzle 32 is connected to a resist solution supply apparatus 100 supplying the resist solution as illustrated in FIG. 1.

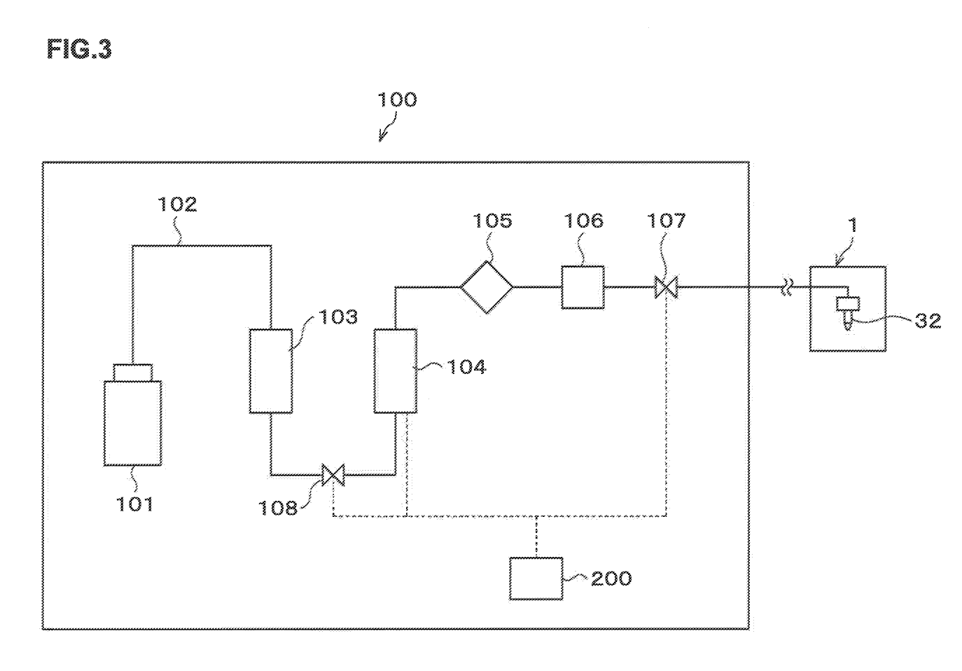

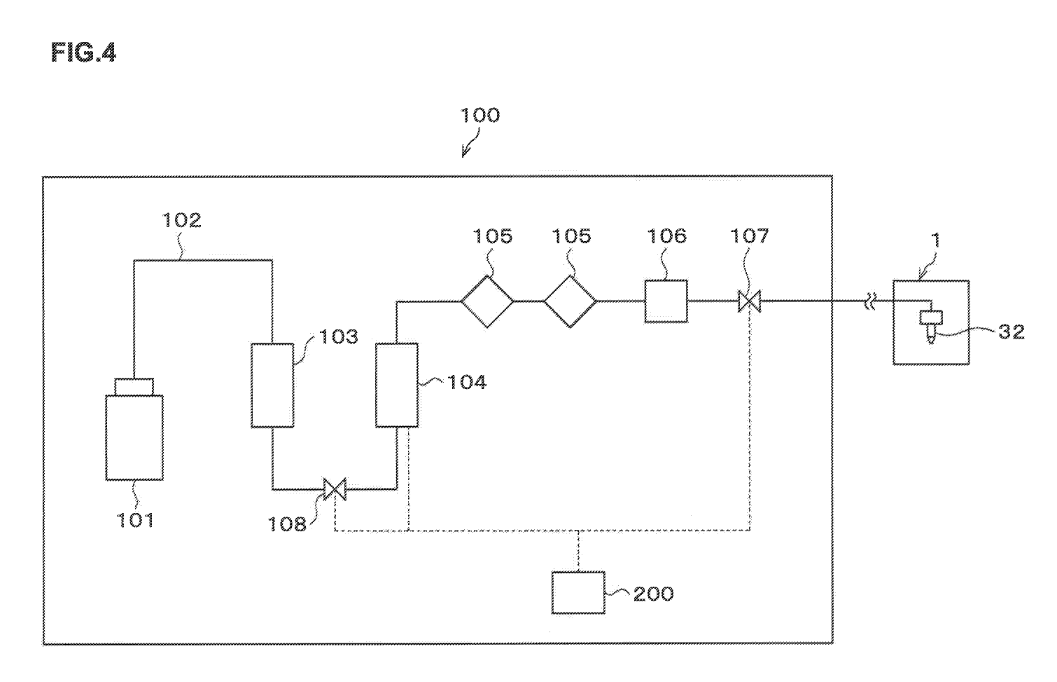

Next, the configuration of the resist solution supply apparatus 100 supplying the resist solution to the coating nozzle 32 in the resist coating apparatus 1 will be described. FIG. 3 is an explanatory view illustrating the outline of the configuration of the resist solution supply apparatus 100.

The resist solution supply apparatus 100 has a resist solution supply source 101 as a treatment solution supply source storing the resist solution therein. At an upper portion of the resist solution supply source 101, a supply pipe 102 for supplying the resist solution to the coating nozzle 32 is provided. More specifically, the supply pipe 102 is provided to connect the resist solution supply source 101 and the coating nozzle 32.

The supply pipe 102 on the downstream side of the resist solution supply source 101 is provided with a liquid end tank 103 for temporarily storing the resist solution. The liquid end tank 103 serves as a buffer tank so that even when the resist solution to be supplied from the resist solution supply source 101 runs out, the resist solution stored in the liquid end tank 103 can be supplied to the coating nozzle 32. Note that at an upper portion of the liquid end tank 103, an exhaust pipe (not illustrated) for exhausting the atmosphere in the liquid end tank 103 is provided.

The supply pipe 102 on the downstream side of the liquid end tank 103 is provided with a pump 104. The pump 104 feeds the resist solution from the resist solution supply source 101 to the coating nozzle 32. The pump 104 further feeds the resist solution to cause the resist solution to pass through a filter 105 in a reciprocation manner at least one time as will be described later. Note that the drive operation of the pump 104 is controlled by a later-described control unit 200.

The supply pipe 102 on the downstream side of the pump 104 is provided with the filter 105 for collecting foreign matter in the resist solution and not allowing the foreign matter from separating therefrom. For the filter 105, various filters are used as long as they collect foreign matter and does not allow the foreign matter to be released therefrom. For example, a filter collecting the foreign matter in the resist solution by adsorbing the foreign matter to its surface layer (hereinafter, referred to as a “surface filter”), for example, a nylon filter in a mesh form may be used for the filter 105. Further, for example, a filter collecting the foreign matter in the resist solution by a plurality of holes formed therein (hereinafter, referred to as a “depth filter”), for example, a membrane-type or a laminated fiber-type filter may be used for the filter 105. Even in the case of using either the surface filter or the depth filter, the foreign matter in the resist solution is collected by the filter 105 and never released therefrom. Note that at an upper portion of the filter 105, an exhaust pipe (not illustrated) exhausting gas (bubbles) generated at the filter 105 is provided.

The supply pipe 102 on the downstream side of the filter 105 is provided with a trap 106 as a blocking mechanism blocking flow of the resist solution is provided. The trap 106 is configured to be variable in volume.

Note that a flow path for the resist solution on the upstream side of the filter 105, namely, the supply pipe 102 between the pump 104 and the filter 105 has a length capable of storing a predetermined supply amount of the resist solution to be supplied from the coating nozzle 32 to one wafer W in the resist coating apparatus 1, namely, a supply amount of the resist solution for one dose (for example, an amount enough to apply the resist to the wafer W). Further, a flow path for the resist solution on the downstream side of the filter 105, namely, the supply pipe 102 between the filter 105 and the pump 106 also has a length capable of storing the supply amount of the resist solution for one dose.

The supply pipe 102 on the downstream side of the trap 106 is provided with a valve 107. For the valve 107, for example, an air-operation valve is used. Note that the opening/closing operation of the valve 107 is controlled by control of the later-described control unit 200 such that the supply of the resist solution from the pump 104 to the coating nozzle 32 can be started or stopped.

Note that between the liquid end tank 103 and the pump 104, namely, on the suction side of the pump 104, a valve 108 is provided. The opening/closing operation of the valve 108 is also controlled by the later-described control unit 200.

The opening/closing operation of the above-described pump 104 and the opening/closing operation of the valves 107, 108 are controlled by the control unit 200. The control unit 200 is composed of a computer including, for example, a CPU and a memory. By executing programs stored in the memory, the supply of the resist solution by the resist solution supply apparatus 100 and the resist coating treatment in the resist coating apparatus 1 can be realized. Note that various programs used for realizing the supply of the resist solution by the resist solution supply apparatus 100 and the resist coating treatment in the resist coating apparatus 1 are stored, for example, in a storage medium (not illustrated) such as a computer-readable hard disk (HD), flexible disk (FD), compact disk (CD), magneto-optical disk (MO), or memory card, and installed from the storage medium into the control unit 200.

Next, the supply of the resist solution to the coating nozzle 32 performed in the resist solution supply apparatus 100 configured as described above and the coating treatment process performed in the resist coating apparatus 1 will be described.

First, by the control unit 200, the valve 107 is opened, the valve 108 is closed, and the pump 104 is driven. Then, a predetermined amount of the resist solution stored between the pump 104 and the coating nozzle 32 is supplied to the wafer W transferred into the resist coating apparatus 1.

Thereafter, the valve 107 is closed, the valve 108 is opened, and the pump 104 is driven. Thus, the resist solution is fed from the resist solution supply source 101 to the liquid end tank 103. The resist solution is once stored in the liquid end tank 103. When a predetermined amount of the resist solution is stored in the liquid end tank 103, the resist solution flows out of the liquid end tank 103 to the coating nozzle 32 side by the resist solution flowing thereafter from the resist solution supply source 101 into the liquid end tank 103.

From the liquid end tank 103 to the coating nozzle 32 side, a predetermined amount of the resist solution to be supplied from the coating nozzle 32 to one wafer W in the resist coating apparatus 1 flows out. In other words, by driving the pump 104, the supply amount of the resist solution for one dose to be supplied from the coating nozzle 32 to the wafer W is supplied. The resist solution is replenished into the pump 104.

Thereafter, the pump 104 is driven with the valve 107 and the valve 108 closed. Then, a predetermined amount of the resist solution is fed from the pump 104 to the trap 106 via the filter 105. In this event, the resist solution passes through the filter 105 so that foreign matter is collected and removed. The foreign matter includes, for example, gel insoluble matter made by a polymer-based compound in the resist solution aggregated with time, so-called resist gel and the like. The resist solution passed through the filter 105 flows into the trap 106 via the supply pipe 102 on the downstream side of the filter 105. Note that since the valve 107 is closed in this event, the resist solution is never discharged from the coating nozzle 32.

Thereafter, with the valve 107 and the valve 108 closed, the pump 104 is driven to perform liquid suction operation. Thus, the resist solution in the trap 106 is fed to the pump 104 via the filter 105 and replenished into the pump 104. In this event, the filter 105 does not allow the collected foreign matter to be released therefrom, so that even if the resist solution is caused to pass again through the filter 105, the foreign matter captured by the filter 105 never scatters again and thus never mixes into the resist solution.

The resist solution flowing out of the liquid end tank 103 as described above passes through the filter 105 in a reciprocation manner between the pump 104 and the trap 106. As a result, the foreign matter in the resist solution can be sufficiently removed. Note that the resist solution may be caused to pass through the filter 105 in a reciprocation manner one time or to pass through the filter 105 a plurality of times. For causing the resist solution to pass through the filter 105 a plurality of times, the number of times of passage of the resist solution through the filter 105 can be controlled by controlling drive of the pump 104 for moving the resist solution in a reciprocation manner in the supply pipe 102 between the pump 104 and the trap 106.

Thereafter, the valve 107 is opened and the pump 104 is driven. Thus, the resist solution from which the foreign matter has been sufficiently removed is supplied to the coating nozzle 32. Note that in this event, the wafer W is transferred into the resist coating apparatus 1.

When the resist solution is supplied to the coating nozzle 32, the wafer W sucked to the spin chuck 20 is rotated by the chuck drive mechanism 21 in the resist coating apparatus 1 and the resist solution is dripped to the central portion of the wafer W from the coating nozzle 32. The resist solution applied to the wafer W is diffused over the entire front surface of the wafer W by the centrifugal force generated by the rotation of the wafer W to form a resist film on the front surface of the wafer W. Then, the rotation of the wafer W is stopped, and the wafer W is transferred out from the top of the spin chuck 20, with which a series of resist coating treatment ends.

According to the above embodiment, the resist solution flowing in the supply pipe 102 is caused to pass through the filter 105 in a reciprocation manner between the pump 104 and the trap 106, so that the foreign matter in the resist solution can be sufficiently removed. In this event, the filter 105 does not allow the collected foreign matter to be released therefrom, so that even if the resist solution is caused to reciprocate, the foreign matter never mixes again in the resist solution. Then, the resist solution from which the foreign matter has been removed as described above is supplied to the wafer W via the coating nozzle 32, thereby making it possible to reduce defects of the resist pattern on the wafer W. In addition, the resist solution is caused to pass through the filter 105 in a reciprocation manner, thus eliminating the necessity of separately providing the circulation path as in the prior art. Therefore, the foreign matter in the resist solution can be removed using the resist solution supply apparatus 100 in a simple configuration. Consequently, the manufacturing cost of the apparatus can be reduced and the occupied area of the apparatus can also be reduced.

Each of the supply pipe 102 on the upstream side of the filter 105 and the supply pipe 102 on the downstream side of the filter 105 has a length capable of storing the supply amount of the resist solution for one dose to be supplied from the coating nozzle 32 to one wafer W and therefore surely causes the resist solution to pass through the filter 105 in a reciprocation manner.

The trap 106 is provided in the supply pipe 102 on the downstream side of the filter 105 and therefore can block the flow of the resist solution. This allows the resist solution to pass through the filter 105 in a reciprocation matter during the waiting time when the resist solution is not supplied to the coating nozzle 32.

By controlling drive of the pump 104 for moving the resist solution in a reciprocation manner in the supply pipe 102, the number of times of passage of the resist solution through the filter 105 can be easily controlled. Consequently, the foreign matter in the resist solution can be more surely removed.

Though each of the supply pipe 102 on the upstream side of the filter 105 and the supply pipe 102 on the downstream side of the filter 105 stores the supply amount of the resist solution for one dose to be supplied from the coating nozzle 32 to one wafer W in the above embodiment, it is only necessary that each of a flow path for the resist solution on the upstream side of the filter 105 and a flow path for the resist solution on the downstream side of the filter 105 is configured to be capable of storing the supply amount of the resist solution for one dose. For example, the pump 104 on the upstream side of the filter 105 may be configured to be capable of storing the supply amount of the resist solution for one dose or the trap 106 on the downstream side of the filter 105 may be configured to be capable of storing the supply amount of the resist solution for one dose. In either case, it is possible to surely cause the resist solution to pass through the filter 105 in a reciprocation manner.

Though the trap 106 provided in the supply pipe 102 on the downstream side of the filter 105 is used as the blocking mechanism to cause the resist solution to pass through the filter 105 in a reciprocation manner in the above embodiment, other various mechanisms can be used for the blocking mechanism. For example, the trap 106 may be omitted and the valve 107 may be used as the blocking mechanism. Further, a tank (not illustrated) may be provided in place of the trap 106 and used as the blocking mechanism. Alternatively, the trap 106 may be omitted and the supply pipe 102 may be provided to vertically stand up so that the vertically standing-up supply pipe 102 may be used as the blocking mechanism. In any case, it is possible to bock the flow of the resist solution in the supply pipe 102 on the downstream side of the filter 105 and cause the resist solution to pass through the filter 105 in a reciprocation manner.

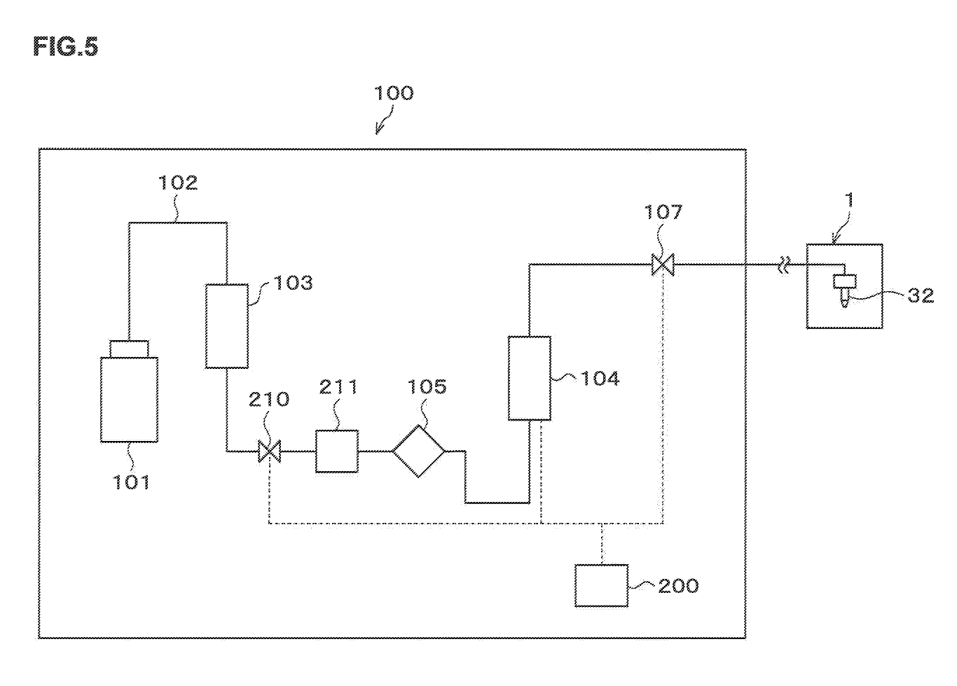

In the resist solution supply apparatus 100 in the above embodiment, the filter 105 may be provided at a plurality of stages in the supply pipe 102 between the pump 104 and the trap 106 as illustrated in FIG. 4. Note that the filter 105 is provided at two stages in the illustrated example but may be provided at three or more stages.

In this case, when the resist solution is caused to flow in the supply pipe 102, the resist solution will pass through the filter 105 two times, so that the foreign matter in the resist solution can be more surely removed. In particular, when the resist solution is caused to pass through the filters 105 in a reciprocation manner as in this embodiment, the resist solution passes through the filter 105 two times every time the resist solution is caused to flow, the effect of removing the foreign matter further increases.

Note that in the resist solution supply apparatus 100 illustrated in FIG. 4, the supply pipe 102 between the filters 105 and 105 at two stages may store the supply amount of the resist solution for one dose to be supplied from the coating nozzle 32 to one wafer W. In this case, it is possible to surely cause the resist solution to pass through the filters 105 in a reciprocation manner.

Further, different kinds of filters may be used for the filter 105 on the upstream side and the filter 105 on the downstream side. For example, a filter in a sieve form provided with a plurality of holes so that the plurality of holes directly collect the foreign matter in the resist solution may be used for the filter 105 on the upstream side. Further, a surface filter or a depth filter may be used, for example, for the filter 105 on the downstream side. In this case, the collected foreign matter may scatter again from the filter 105 on the upstream side, but the collected foreign matter never scatters again from the filter 105 on the downstream side, so that the foreign matter in the resist solution can be appropriately removed. In addition, for instance, the filter 105 on the upstream side collects foreign matter with a large diameter and the filter 105 on the downstream side collects foreign matter with a small diameter to surely remove the foreign matter in the resist solution.

The filter 105 is provided on the downstream side of the pump 104 in the above embodiment but may be provided on the upstream side of the pump 104. In this case, the filter 105 is provided in the supply pipe 102 between the liquid end tank 103 and the pump 104 as illustrated in FIG. 5. The supply pipe 102 on the upstream side of the filter 105 and between the liquid end tank 103 and the filter 105 is provided with a valve 210 blocking the flow of the resist solution. The opening/closing operation of the valve 210 is controlled by the control of the later-described control unit 200. Further, the supply pipe 102 on the upstream side of the filter 105 and between the valve 210 and the filter 105 is provided with a trap 211 blocking the flow of the resist solution. The trap 211 is configured to be variable in volume. The supply pipe 102 between the trap 211 and the filter 105 has a length capable of storing the supply amount of the resist solution for one dose to be supplied from the coating nozzle 32 to one wafer W. Further, the supply pipe 102 between the filer 105 and the pump 104 also has a length capable of storing the supply amount of the resist solution for one dose.

Then, by the control unit 200, the valve 210 is opened and the pump 104 is driven. Then, the resist solution flowing out of the liquid end tank 103 flows into the supply pipe 102 on the downstream side. After a predetermined amount of the resist solution is replenished into the pump 104, the valve 210 is closed. Then, between the trap 211 and the pump 104, the resist solution is caused to pass through the filter 105 in a reciprocation manner by drive of the pump 104. Thereafter, by opening the valve 107 and driving the pump 104, the resist solution which has passed through the filter 105 in a reciprocation manner and from which the foreign matter has been removed is supplied to the coating nozzle 32.

Also in this embodiment, the resist solution flowing in the supply pipe 102 is caused to pass through the filter 105 in a reciprocation manner between the trap 211 and the pump 104, so that the foreign matter in the resist solution can be sufficiently removed. Then, the resist solution from which the foreign matter has been removed as described above is supplied to the wafer W via the coating nozzle 32, so that defects of the resist pattern on the wafer W can be reduced.

Though each of the supply pipe 102 on the upstream side of the filter 105 and the supply pipe 102 on the downstream side of the filter 105 stores the supply amount of the resist solution for one dose to be supplied from the coating nozzle 32 to one wafer W in the above embodiment, it is only necessary that each of a flow path for the resist solution on the upstream side of the filter 105 and a flow path for the resist solution on the downstream side of the filter 105 is configured to be capable of storing the supply amount of the resist solution for one dose. For example, a tank (not illustrated) temporarily storing the resist solution may be provided on the downstream side of the filer 105 and configured to be capable of storing the supply amount of the resist solution for one dose. Further, the trap 211 on the upstream side of the filer 105 may be configured to be capable of storing the supply amount of the resist solution for one dose. In either case, the resist solution can be surely caused to pass through the filter 105 in a reciprocation manner.

Though the case of supplying the resist solution to the coating nozzle 32 has been described in the above embodiments, the present invention is also effective to the case of supplying a treatment solution other than the resist solution. The present invention is effective, for example, when supplying a developing solution, a rinse solution (a solvent for the resist solution), pure water, a chemical and the like as the treatment solutions, namely, when supplying various kinds of treatment solutions onto the wafer W in the photolithography processing. By supplying the aforementioned other treatment solution other than the resist solution using the treatment solution supply method (treatment solution supply apparatus) of the present invention, the treatment solution from which the foreign matter has been sufficiently removed can be supplied onto the wafer W. Consequently, defects on the wafer W can be reduced.

Preferred embodiments of the present invention have been described above with reference to the accompanying drawings, but the present invention is not limited to the embodiments. It should be understood that various changes and modifications are readily apparent to those skilled in the art within the scope of the spirit as set forth in claims, and those should also be covered by the technical scope of the present invention. The present invention is not limited to the examples but can take various forms. The present invention is also applicable to the case where the substrate is another substrates such as an FPD (Flat Panel Display), a mask reticle for a photomask, or the like other than the wafer.

The present invention is useful in supplying a treatment solution to a treatment solution supply unit supplying a treatment solution to a substrate, for example, a semiconductor wafer or the like.

What is claimed is:

1. A treatment solution supply method for supplying a treatment solution to a treatment solution supply unit supplying the treatment solution to a substrate,
wherein a supply pipe connected to the treatment solution supply unit is provided with a filter collecting foreign matter in the treatment solution and not allowing the foreign matter to be released therefrom, and
wherein the treatment solution flowing in the supply pipe is caused to pass through the filter in a reciprocation manner at least one time and then supplied to the treatment solution supply unit.

2. The treatment solution supply method as set forth in claim 1,
wherein each of a flow path for the treatment solution on an upstream side of the filter and a flow path for the treatment solution on a downstream side of the filter is configured to be capable of temporarily storing a predetermined supply amount of the treatment solution to be supplied from the treatment solution supply unit to the substrate.

3. The treatment solution supply method as set forth in claim 2,
wherein the filter is for collecting the foreign matter in the treatment solution by adsorbing the foreign matter to a surface layer of the filter.

4. The treatment solution supply method as set forth in claim 1,
wherein the supply pipe is provided with a pump for causing the treatment solution to flow in the supply pipe, and
wherein a number of times of passage of the treatment solution through the filter in a reciprocation manner is controlled based on drive of the pump.

5. The treatment solution supply method as set forth in claim 4,
wherein the filter is for collecting the foreign matter in the treatment solution by adsorbing the foreign matter to a surface layer of the filter.

6. The treatment solution supply method as set forth in claim 1,
wherein the filter is provided at a plurality of stages, and
wherein the treatment solution passes through the filters at the plurality of stages in a reciprocation manner.

7. The treatment solution supply method as set forth in claim 6,
wherein the filter is for collecting the foreign matter in the treatment solution by adsorbing the foreign matter to a surface layer of the filter.

8. The treatment solution supply method as set forth in claim 1,
wherein the filter is for collecting the foreign matter in the treatment solution by adsorbing the foreign matter to a surface layer of the filter.

9. The treatment solution supply method as set forth in claim 1,
wherein the filter is for physically collecting the foreign matter in the treatment solution by a plurality of holes formed inside the filter.

10. A non-transitory computer-readable storage medium storing a program operating on a computer of a control unit controlling a treatment solution supply apparatus to cause the treatment solution supply apparatus to perform a treatment solution supply method,
wherein the treatment solution supply method is a method for supplying a treatment solution to a treatment solution supply unit supplying the treatment solution to a substrate,
wherein a supply pipe connected to the treatment solution supply unit is provided with a filter collecting foreign matter in the treatment solution and not allowing the foreign matter to be released therefrom, and
wherein the treatment solution flowing in the supply pipe is caused to pass through the filter in a reciprocation manner at least one time and then supplied to the treatment solution supply unit.

11. A treatment solution supply apparatus for supplying a treatment solution to a treatment solution supply unit supplying the treatment solution to a substrate, comprising:
a treatment solution supply source storing the treatment solution therein;
a supply pipe for supplying the treatment solution from said treatment solution supply source to said treatment solution supply unit;
a filter provided in said supply pipe for collecting foreign matter in the treatment solution and not allowing the foreign matter to be released therefrom;
a pump provided in said supply pipe for causing the treatment solution to flow; and
a control unit configured to control said pump to cause the treatment solution flowing in said supply pipe to pass through said filter in a reciprocation manner at least one time and then supply the treatment solution to said treatment solution supply unit.

12. The treatment solution supply apparatus as set forth in claim 11,
wherein each of a flow path for the treatment solution on an upstream side of said filter and a flow path for the treatment solution on a downstream side of said filter is configured to be capable of temporarily storing a predetermined supply amount of the treatment solution to be supplied from said treatment solution supply unit to the substrate.

13. The treatment solution supply apparatus as set forth in claim 12,
wherein said filter is for collecting the foreign matter in the treatment solution by adsorbing the foreign matter to a surface layer of said filter.

14. The treatment solution supply apparatus as set forth in claim 11,
wherein said control unit controls a number of times of passage of the treatment solution through said filter in a reciprocation manner based on drive of said pump.

15. The treatment solution supply apparatus as set forth in claim 14,
wherein said filter is for collecting the foreign matter in the treatment solution by adsorbing the foreign matter to a surface layer of said filter.

16. The treatment solution supply apparatus as set forth in claim 11,
wherein said filter is provided at a plurality of stages.

17. The treatment solution supply apparatus as set forth in claim 11,
wherein said filter is for collecting the foreign matter in the treatment solution by adsorbing the foreign matter to a surface layer of said filter.

18. The treatment solution supply apparatus as set forth in claim 11,
wherein said filter is for physically collecting the foreign matter in the treatment solution by a plurality of holes formed inside said filter.

19. The treatment solution supply apparatus as set forth in claim 11,
wherein said filter is provided on an upstream side of said pump.

20. The treatment solution supply apparatus as set forth in claim 11,
wherein said filter is provided on a downstream side of said pump, and
wherein said supply pipe on a downstream side of said filter is provided with a blocking mechanism capable of blocking flow of the treatment solution.
